(19) United States
(12) Patent Application Publication
(10) Pub. No.: US 2024/0132293 A1
(43) Pub. Date: Apr. 25, 2024

(54) FEEDING SCREW MACHINE FOR FEEDING A PROCESSING SCREW MACHINE

(71) Applicant: Coperion GmbH, Stuttgart (DE)

(72) Inventors: Stefan HUBER, Friolzheim (DE); Markus SCHMUDDE, Steinheim a.d. Murr (DE); Svetlana MARINOVA, Stuttgart (DE); Ralf KÜHN, Erligheim (DE); Kai KLUGE, Illingen (DE); Oleg RUDI, Bietigheim-Bissingen (DE); Dirk KYRION, Sternenfels (DE); Robert KESSLER, Sindelfingen (DE); Leonid LIBER, Rutesheim (DE); Marina MATTA, Gemmingen (DE); Jochen SCHOFER, Stuttgart (DE)

(73) Assignee: Coperion GmbH, Stuttgart (DE)

(21) Appl. No.: 18/264,205

(22) PCT Filed: Jan. 28, 2022
(86) PCT No.: PCT/EP2022/052056

§ 371 Date: Aug. 3, 2023

(30) Foreign Application Priority Data
Feb. 4, 2021 (EP) 21155262.5

(51) Int. Cl. B65G 33/08

(52) U.S. Cl. CPC B65G 33/08

(57) ABSTRACT

A feeding screw machine for feeding a processing screw machine comprises a housing with at least two housing bores formed therein and screw shafts rotatably arranged in the at least two housing bores. The at least two housing bores and the at least two screw shafts define a free volume in a respective cross-sectional plane, which decreases monotonically at least in some regions for continuous compression of a material in a conveying direction. This enables an improved supply of material with a low bulk density.

### CROSS-REFERENCES TO RELATED APPLICATIONS

This application claims the priority of European Patent Application, Serial No. EP 21 155 262.5, filed Feb. 4, 2021, the content of which is incorporated herein by reference in its entirety as if fully set forth herein.

### FIELD OF THE INVENTION

The invention relates to a feeding screw machine for feeding a processing screw machine. Furthermore, the invention relates to a processing installation and a method for operating a processing installation having such a feeding screw machine.

### BACKGROUND OF THE INVENTION

From WO 2015/051859 A1 (corresponding to US 2016/0346984 A1), a side-feed feeding screw machine for feeding material into an extruder is known. For freeing the material from accompanying gaseous substances, such as air, the side-feeding screw machine comprises a degassing housing arranged upstream of a conveying direction on the housing of the side-feeding screw machine. The side-feeding screw machine comprises screw conveyors having a large inclination and a thrust edge profile in the region of a supply opening of the material. In the downstream conveying direction, the side-feeding screw machine has screw conveyors that have a reduced inclination and a normal sealing profile. This compacts the material and conveys it into the extruder with a certain pressure.

### SUMMARY OF THE INVENTION

It is an object of the invention to create a feeding screw machine which enables an improved feeding of material with a low bulk density into a processing screw machine. In particular, the material shall have a bulk density of at most 600 g/dm³, in particular at most 250 g/dm³, in particular at most 200 g/dm³, and in particular at most 100 g/dm³. The material shall for example be recycled material. The feeding screw machine shall in particular allow a high throughput for the material such that the processing of the material in the processing screw machine is possible in a simple and economical manner

This object is achieved by a feeding screw machine for feeding a processing screw machine having a housing, at least two housing bores formed in the housing and penetrating each other, a supply opening formed in the housing for supplying material into the at least two housing bores, a feeding opening formed in the housing for feeding the material to a processing screw machine, and at least two screw shafts rotatably arranged in the at least two housing bores for conveying the material in a conveying direction from the supply opening to the feeding opening, wherein the at least two housing bores and the at least two screw shafts in a respective cross-sectional plane define a free volume V(x)=A(x)·H(x), wherein A(x) describes a free cross-sectional area in the cross-sectional plane, H(x) describes a pitch of the screw shafts on the basis of an inclination in the cross-section plane, and x describes a conveying point in the conveying direction and wherein for continuous compression of the material, the free volume V(x) decreases monotonically in the conveying direction at least in some regions. Due to the fact that the free volume V(x) decreases monotonically in the conveying direction, at least region-wise, the material is continuously compressed in a simple and reliable manner while being conveyed. The compression may be adjusted in a desired manner via the decrease of the free volume V(x). The processing screw machine is fed with the compressed material, whereby a high filling degree of the processing screw machine is achieved. Due to the high filling level, the processing screw machine can be operated in a simple and economical manner.

The region-wise monotonic decrease of the free volume V(x) is to be understood in particular mathematically in such a way that the free volume V(x) does not change abruptly, but a local derivative of the free volume V(x) in the conveying direction is at least region-wise continuous and negative. The local derivative may also be equal to zero in some regions. Preferably, the free volume V(x) decreases strictly monotonically at least in some regions so that the local derivative of the free volume V(x) is exclusively negative in the conveying direction in some regions. Preferably, the free volume V(x) decreases monotonically, in particular strictly monotonically, at least in a region between a downstream end of the supply opening and the feeding opening, in particular in the entire region between the downstream end of the supply opening and the feeding opening.

The free volume V(x) is defined as the product of the free cross-sectional area A(x) and the pitch H(x) of the at least two screw shafts in a cross-sectional plane E(x) at the conveying point x. The free cross-sectional area A(x) is the area between the housing and the at least two screw shafts in the cross-sectional plane E(x). The pitch H(x) is defined as the height in the conveying direction at an inclination S(x) of the at least two screw shafts in the cross-sectional plane E(x) and at one revolution or one rotation. The pitch H(x) is in particular a notional value related to the inclination S(x) in the cross-sectional plane E(x) when the inclination S(x) changes in the conveying direction, in particular when the inclination S(x) decreases strictly monotonically. If the inclination S(x) decreases strictly monotonically in the conveying direction, the pitch H(x) is greater than an actual pitch of the at least two screw shafts.

The inclination S(x) is defined in the cross-sectional plane E(x) at a screw outer diameter Da(x), i.e. at a screw crest. If the axes of rotation of the at least two screw shafts intersect the cross-sectional plane E(x) perpendicularly, all screw crests of the at least two screw shafts have the same inclination S(x) so that the calculation of the free volume V(x) is independent of which screw crest is considered. If the axes of rotation of the at least two screw shafts intersect the cross-sectional plane E(x) at an angle unequal to 90° due to a conical arrangement of the at least two screw shafts, the inclinations at the screw crests in the cross-sectional plane E(x) may differ slightly from each other. In this case, the inclination S(x) shall be an average value of the inclinations of all screw crests of the at least two screw shafts in the cross-sectional plane E(x).

For decreasing the free volume V(x), the free cross-sectional area A(x) and/or the pitch H(x) decreases monotonically, in particular strictly monotonically, at least in some regions in the conveying direction. Preferably, the free cross-sectional area A(x) and the pitch H(x) decrease monotonically, in particular strictly monotonically, at least in some regions in the conveying direction. Upon conveying, the material is thereby compressed transversely to the conveying direction and in the conveying direction.

Preferably, the feeding screw machine is designed as a side-feeding screw machine. The side-feeding screw machine enables a lateral connection to the processing screw machine. The at least two housing bores penetrate each other and, in particular in cross section, have the shape of a horizontal figure eight. Preferably, the feeding screw machine is designed with two shafts. In particular, the feeding screw machine has exactly two housing bores and exactly two associated screw shafts. Preferably, the feeding opening has the shape of a horizontal figure eight in cross-section. The at least two screw shafts are in particular designed to be driven in rotation in the same direction or in opposite directions and/or to mesh tightly.

The at least two screw shafts each comprise a shaft and at least one screw element. The at least one screw element is formed in one piece and/or two pieces with the associated shaft. In the case of a two-piece design, the at least one screw element is detachably connected to the shaft in a rotationally fixed manner The at least one screw element of the respective screw shaft in particular has a thrust edge profile on an active flank and/or a passive flank. he thrust edge profile on the active flank and/or on the passive flank may vary in the conveying direction. In particular, a flank angle on the active flank and/or on the passive flank may increase in the conveying direction. For example, in the conveying direction, the flank angle of the passive flank can increase more than the flank angle on the active flank. This results in a good intake behavior in the region of the supply opening and sufficient stiffness in the region of the feeding opening and the compressed material. The at least two screw shafts have a number of threads N, wherein: 1≤N≤3, in particular 1≤N≤2, and in particular N=2. The respective screw shaft thus has N screw flights with associated screw crests.

Preferably, the feeding screw machine comprises an inlet hopper which is arranged on the housing and opens into the supply opening. Preferably, a free inlet cross-sectional area of the inlet hopper is at least regionally increasing and/or regionally decreasing and/or regionally constant in a falling direction. Preferably, the inlet hopper is configured in a divided manner In particular, the inlet hopper is connected to a degassing device. The supply opening forms a supply chute in the housing. Preferably, a free inlet cross-sectional area of the supply chute is at least regionally increasing and/or regionally decreasing and/or regionally constant in a falling direction.

The feeding screw machine preferably comprises at least one temperature control device. The at least one temperature control device can be operated by means of a temperature control fluid and/or electrically. The at least one temperature control device comprises, for example, at least one fluid channel and/or at least one electrical heating element. The at least one fluid channel is in particular integrated into the housing. The at least one electrical heating element is integrated into the housing and/or arranged on the outside of the housing.

A feeding screw machine configured such that a first free volume V(x₁) is defined in a first cross-sectional plane at a first conveying point x₁ of the at least two screw shafts and a second free volume V(x₂) is defined in a second cross-sectional plane at a second conveying point x₂ of the at least two screw shafts which is located downstream of the first conveying point x₁ in the conveying direction, wherein: 1<V(x₁)/ V(x₂)≤20, in particular 2≤V(x₁)/V(x₂)≤15, and in particular 4≤V(x₁)/V(x₂)≤10, ensures an improved supply of the material into a processing screw machine. The first conveying point x₁ is, for example, a screw shaft start of the at least two screw shafts. The second conveying point x₂ is, for example, a housing end which is arranged adjacent to a screw shaft end of the at least two screw shafts. The ratio of the first free volume V(x₁) at the first conveying point x₁ to the second free volume V(x₂) defines a compression. The greater the ratio V(x₁)/V(x₂), the greater the compression of the material upon conveying from the first conveying point x₁ to the second conveying point x₂. The following applies to the first free volume V(x₁): V(x₁)=A(x₁)·H(x₁). Correspondingly, the following applies to the second free volume V(x₂)=A(x₂)·H(x₂).

For a ratio of a first free cross-sectional area A(x₁) in the first cross-sectional plane E(x₁) at the conveying point x₁ to a second free cross-sectional area A(x₂) in the cross-sectional plane E(x₂) at the conveying point x₂, the following applies in particular: 1≤A(x₁)/A(x₂)≤8, in particular 1.5≤A(x₁)/A(x₂)≤7, in particular 2≤A(x₁)/A(x₂)≤6.

For a ratio of a first pitch H(x₁) based on a first inclination S(x₁) in the first cross-sectional plane E(x₁) to a second pitch H(x₂) based on a second inclination S(x₂) in the cross-sectional plane E(x₂), the following applies in particular: 1≤H(x₁)/H(x₂)≤8, in particular 1.1≤H(x₁)/H(x₂)≤5, and in particular 1.2≤H(x₁)/H(x₂)≤3.

A feeding screw machine configured such that a screw outer diameter of the at least two screw shafts decreases at least regionally in the conveying direction ensures an improved supply of the material into a processing screw machine. Due to the fact that the screw outer diameter of the at least two screw shafts decreases monotonically at least in some regions in the conveying direction, in particular decreases strictly monotonically, the at least two screw shafts are conical at least in some regions. Preferably, the screw outer diameter of the at least two screw shafts decreases monotonically, in particular strictly monotonically, over the entire length of the at least two screw shafts in the conveying direction. A local derivative of the screw outer diameter in the conveying direction is preferably constant. The conical design of the at least two screw shafts ensures a large free cross-sectional area in the region of the supply opening and/or a high compression of the material upon conveying.

For the conical design of the at least two screw shafts, a tapering K is defined, wherein:

$$K = \frac{{{D}_{a} ( {x}_{1} )}^{2}}{L \cdot {D}_{a} ( {x}_{3} )} ,$$

wherein
Dₐ(x₁) describes the screw outer diameter of the at least two screw shafts at a conveying point x₁ corresponding to a screw shaft start of the at least two screw shafts, and
Dₐ(x₃) describes a screw outer diameter of the at least two screw shafts at a conveying point x₃ which corresponds to a screw shaft end of the at least two screw shafts, and
L describes a length of the at least two screw shafts.

For the tapering K, the following applies in particular: 0.05≤K≤1, in particular 0.3≤K≤0.4.

For a ratio Dₐ(x₁)/Dₐ(x₃), in particular: 1≤Dₐ(x₁)/Dₐ(x₃)≤4, in particular 1.2≤Dₐ(x₁)/Dₐ(x₃)≤3, and in particular 1.3≤Dₐ(x₁)/Dₐ(x₃)≤2.5.

A screw inner diameter Dᵢ(x) of the at least two screw shafts is constant or monotonically decreasing or strictly monotonically decreasing at least in some regions in the conveying direction.

For a ratio of a screw inner diameter Dᵢ(x₁) of the at least two screw shafts at the conveying point x₁ and a screw inner diameter D₁(x₃) of the at least two screw shafts at the conveying point x₃, the following applies in particular: 1≤Dᵢ(x₁)/Dᵢ(x₃)≤5, in particular 1.25≤Dᵢ(x₁)/Dᵢ(x₃)≤4, and in particular 1.5≤Dᵢ(x₁)/Dᵢ(x₃)≤3.

A feeding screw machine configured such that a tapering

$$K = \frac{{{D}_{a} ( {x}_{1} )}^{2}}{L \cdot {D}_{a} ( {x}_{3} )}$$

is defined for a conical configuration of the at least two screw shafts, wherein 0.05≤K≤1 applies, wherein Dₐ(x₁) describes the screw outer diameter of the at least two screw shafts at a conveying point x₁ which corresponds to a screw shaft start of the at least two screw shafts, Dₐ(x₃) describes a screw outer diameter of the at least two screw shafts at a conveying point x₃ which corresponds to a screw shaft end of the at least two screw shafts, and L describes a length of the at least two screw shafts, ensures an improved supply of the material into a processing screw machine. The following applies in particular to the tapering K: 0.1≤K≤0.9, in particular 0.15≤K≤0.8, in particular 0.2≤K≤0.7, in particular 0.25≤K≤0.6 and in particular 0.3≤K≤0.4.

For a ratio Dₐ(x₁)/Dₐ(x₃), in particular: 1≤Dₐ(x₁)/Dₐ(x₃)≤4, in particular 1.2≤Dₐ(x₁)/Dₐ(x₃)≤3, and in particular 1.3≤Dₐ(x₁)/Dₐ(x₃)≤2.5.

A screw inner diameter Dᵢ(x) of the at least two screw shafts is constant or monotonically decreasing or strictly monotonically decreasing at least in some regions in the conveying direction.

For a ratio of a screw inner diameter Dᵢ(x₁) of the at least two screw shafts at the conveying point x₁ and a screw inner diameter D₁(x₃) of the at least two screw shafts at the conveying point x₃, the following applies in particular: 1≤Dᵢ(x₁)/Dᵢ(x₃)≤5, in particular 1.25≤Dᵢ(x₁)/Dᵢ(x₃)≤4, and in particular 1.5≤Dᵢ(x₁)/Dᵢ(x₃)≤3.

The smaller the tapering K, the greater the length L. If the length L is too great, large lever forces act on the at least two screw shafts, which places great stress on the bearings for supporting the at least two screw shafts on the housing and/or the bearings of a gearbox. Furthermore, if the length L of the at least two screw shafts is too great, the production of the feeding screw machine is uneconomical.

The greater the tapering K, the smaller the length L. If the length L is too small, the conveying efficiency of the at least two screw shafts is poor.

The length L is in particular the distance between the conveying points x₁ and x₃. The following applies in particular to the length L: 0.3 m≤L≤4 m, in particular 0.5 m≤L≤3,5 m, in particular 0.7 m≤L≤3 m and in particular 0.9 m≤L≤2.5 m.

In an axial section, an envelope of the respective screw shaft encloses an angle with the associated axis of rotation which is in particular at least 2 degrees and at most 10 degrees, in particular at least 2.5 degrees and at most 8 degrees, and in particular at least 3 degrees and at most 6 degrees.

The envelope of the respective screw shaft is defined by the screw outer diameter at the respective conveying point.

A feeding screw machine configured such that a housing bore diameter of the at least two housing bores decreases at least regionally in the conveying direction ensures an improved supply of the material into a processing screw machine. The housing bore diameter decreases monotonically, in particular strictly monotonically, at least in some regions in the conveying direction. The following applies to a relative clearance s(x) between the housing and the at least one screw shaft at a conveying point x:

$$s ( x ) = \frac{{D}_{G} ( x ) - {D}_{a} ( x )}{{D}_{a} ( x )} ,$$

wherein
D_{G}(x) describes the housing bore diameter at the conveying point x and
Dₐ(x) describes a screw outer diameter of the at least two screw shafts at the conveying point x.

Preferably, the relative clearance s(x) is constant in the conveying direction x and/or increases in the conveying direction.

For the ratio of a housing length L_{G} of the housing to a screw outer diameter Dₐ(x₁) of the at least two screw shafts at a conveying point x₁ which corresponds to a screw shaft start, the following preferably applies: 2≤L_{G}/Dₐ(x₁)≤15, in particular 3≤L_{G}/Dₐ(x₁)≤10, and in particular 4<L_{G}/Dₐ(x₁)≤6.

A feeding screw machine configured such that axes of rotation associated with the at least two screw shafts enclose an angle α, wherein: 0°<α≤45°, in particular 1°≤α≤20°, and in particular 2°≤α≤10°, ensures an improved supply of the material into a processing screw machine. Due to the fact that the axes of rotation enclose the angle α, the axes of rotation run towards one another in the conveying direction. The conical arrangement of the at least two screw shafts ensures a large free cross-sectional area in the region of the supply opening and/or a high compression upon conveying. The voluminous material with the low bulk density can be supplied in a simple manner through the supply opening.

The at least two screw shafts are arranged concentrically to the associated axes of rotation in the at least two housing bores. Preferably, the feeding screw machine comprises at least one electric drive motor and/or at least one gear, in particular a branching gear. Preferably, the gear has at least two output shafts whose associated axes of rotation enclose an angle β, wherein: β=α. Due to such a conical design of the gear, the screw shafts can be driven in rotation in a simple manner

Furthermore, the feeding screw machine may comprise at least two direct drives which directly drive the at least two screw shafts in rotation, i.e. without interposing a gear. The feeding screw machine may comprise at least one angle compensation element, such as a cardan joint and/or a transmission belt and/or a transmission chain, which compensates an angle between the respective axis of rotation of the at least two screw shafts and an associated output shaft of a gear and/or a drive shaft of a drive.

For sealing the at least two screw shafts against the housing, the feeding screw machine has in particular at least two packing glands. The at least two packing glands are in particular arranged on an outer side of the housing, preferably in the region of a gearbox lantern. This gearbox lantern mechanically connects the housing to the gear. The coupling of the at least two screw shafts with associated output shafts of the gear takes place inside the gearbox lantern.

A feeding screw machine configured such that the at least two screw shafts define in the respective cross-sectional plane a screw outer diameter Dₐ(x) and a screw inner diameter Dᵢ(x), wherein: 1.55<Dₐ(x)/Dᵢ(x)≤2.5, in particular 1.8≤Dₐ(x)/Dᵢ(x)≤2.2, ensures an improved supply of the material into a processing screw machine. The ratio Dₐ(x)/Dᵢ(x) is constant and/or decreasing and/or increasing at least in some regions in the conveying direction. By means of the ratio Dₐ(x)/Dᵢ(x), the thread depth of the at least two screw shafts is adjusted in a desired manner The thread depth has an influence on the free volume V(x). For a ratio

$$d = \frac{{D}_{a} ( {x}_{1} ) / {D}_{1} ( {x}_{1} )}{{D}_{a} ( {x}_{3} ) / {D}_{i} ( {x}_{3} )} ,$$

wherein
Dₐ(x₁) indicates a screw outer diameter of the at least two screw shafts at a conveying point x₁ which corresponds to a screw shaft start of the at least two screw shafts,
Dᵢ(x₁) represents a screw inner diameter of the at least two screw shafts at the conveying point x₁,
Dₐ(x₃) indicates a screw outer diameter of the at least two screw shafts at a conveying point x₃ corresponding to a screw shaft end of the at least two screw shafts, and
Dᵢ(x₃) represents a screw inner diameter of the at least two screw shafts at the conveying point x₃.

For the ratio d, the following applies in particular: 0.62≤d≤1.22, in particular 0.82≤d≤1. Preferably, the following applies: d=1.

A feeding screw machine configured such that the at least two screw shafts in the respective cross-sectional plane define the pitch H(x) and a screw outer diameter Dₐ(x), wherein: 1<H(x)/Dₐ(x)≤2, in particular 1.2≤H(x)/Dₐ(x)≤1.5, ensures an improved supply of the material into a processing screw machine. The ratio H(x)/Dₐ(x) is constant and/or decreasing and/or increasing at least in portions in the conveying direction. Preferably, the following applies for a ratio

$$h = \frac{H ( {x}_{1} ) / {D}_{a} ( {x}_{1} )}{H ( {x}_{3} ) / {D}_{a} ( {x}_{3} )} ,$$

wherein
H(x₁) indicates a pitch of the at least two screw shafts based on an inclination S(x₁) at a conveying point x₁ which corresponds to a screw start of the at least two screw shafts,
Dₐ(x₁) describes a screw outer diameter of the at least two screw shafts at the conveying point x₁,
H(x₃) represents a pitch of the at least two screw shafts based on an inclination S(x₃) at a conveying point x₃ which corresponds to a screw shaft end of the at least two screw shafts,
Dₐ(x₃) describes a screw outer diameter of the at least two screw shafts at the conveying point x₃.

For the ratio h, the following applies in particular: 0.5≤h≤1.5, in particular 0.8≤h≤1.2, and in particular 0.9≤h≤1.1. Preferably, the following applies: h=1.

The supply opening has a length L_{Z} in the conveying direction. The following applies in particular to the length L_{Z}: H(x₁)≤L_{Z}≤2·H(x₁), in particular 1.2·H(x₁)≤L_{Z}≤1.5·H(x₁).

A feeding screw machine configured such that the housing comprises at least two housing portions ensures an improved supply of the material into a processing screw machine. A first housing portion comprises the supply opening, whereas a second housing portion comprises the feeding opening. The at least two housing portions allow a length L_{G} of the housing to be adjusted in a simple and flexible manner Due to the fact that the housing has a greater length L_{G}, the at least two screw shafts also have a greater length L. Via the length L of the at least two screw shafts, the compression of the material upon conveying in the conveying direction can be adjusted in a simple and flexible manner

The at least two housing portions are arranged one after the other in the conveying direction and connected to each other to form the housing. A final housing portion is connected to the processing screw machine.

A feeding screw machine configured such that the at least two screw shafts each comprise a shaft and at least one screw element which are formed in one piece with one another ensures an improved supply of the material into a processing screw machine. Due to the fact that the shaft of the respective screw shaft is formed in one piece with at least one associated screw element, the at least two screw shafts can be manufactured in a simple manner in such a way that the free volume V(x) decreases in the desired manner in the conveying direction. The at least two screw shafts also have a high stiffness. The at least two screw shafts can each comprise at least one treatment element, in particular at least one screw element and/or at least one kneading element, which is formed in two pieces with the associated shaft and is reversibly connected to the associated shaft. As a result, for example, treatment elements that are subject to a great deal of wear can be easily replaced. Moreover, the at least two screw shafts can be adapted in a simple manner to the material and/or to a desired conveyance and/or compression of the material. For example, the at least two screw shafts may comprise treatment elements with blades that crush the material being conveyed. Preferably, the at least two screw shafts each comprise at least one kneading block having a plurality of disc-shaped kneading elements integrally connected to each other. A free volume is not defined in the region of the at least one kneading element of the respective screw shaft.

A feeding screw machine comprising at least one degassing device ensures an improved supply of the material into a processing screw machine. The at least one degassing device is in particular connected to the housing and/or to an inlet hopper. The at least one degassing device serves in particular to remove air during the supply of the material into the at least two housing bores and/or during the compression of the material in the at least two housing bores. This simplifies and improves the filling of the at least two housing bores in the region of the supply opening and/or the compression of the material. In particular, a conveying efficiency or throughput of the feeding screw machine is improved. Preferably, the feeding screw machine comprises a plurality of degassing openings formed in the housing one after the other in the feeding direction. The degassing openings are preferably formed on an underside and/or on an upper side of the housing. In particular, a respective degassing insert is arranged in the degassing openings. The degassing openings are connected to the at least one degassing device. The at least one degassing device comprises a respective suction line which is connected to the associated degassing opening and a suction unit for generating a negative pressure. The respective degassing opening has a free degassing area A_{E}, wherein the following applies for a ratio of the free degassing area A_{E} to a mean screw outer diameter Dₐₘ squared: 0.3≤A_{E}/Dₐₘ²≤6, in particular 0.8≤A_{E}/Dₐₘ²≤4.5, and in particular 1.3≤A_{E}/Dₐₘ²≤3.5.

The following applies in particular to the mean screw outer diameter Dₐₘ:

$${D}_{am} = \frac{{D}_{a} ( {x}_{1} ) + {D}_{a} ( {x}_{3} )}{2} ,$$

wherein
Dₐ(x₁) represents a screw outer diameter of the at least two screw shafts at a conveying point x₁ which corresponds to a screw shaft start of the at least two screw shafts, and
Dₐ(x₃) indicates a screw outer diameter of the at least two screw shafts at a conveying point x₃ which corresponds to a screw shaft end of the at least two screw shafts.

The supply opening has a supply opening cross-sectional area A_{Z}, wherein the following applies in particular to a ratio of the supply opening cross-sectional area A_{Z} to the mean screw outer diameter Dam squared: 2≤A_{Z}/Dₐₘ²≤7, in particular 2.5≤A_{Z}/Dₐₘ²≤5.5, and in particular 3≤A_{Z}/Dₐₘ²≤4.5.

A feeding screw machine configured such that at least one discharge opening is formed in the housing ensures an improved supply of the material into a processing screw machine. The compression of the material forces liquid out of the material. The liquid can be discharged from the at least two housing bores by means of the at least one discharge opening before the liquid enters the processing screw machine. The at least one discharge opening is arranged between the supply opening and the feeding opening, preferably close to the feeding opening. The at least one discharge opening is formed on an underside of the housing so that the liquid is discharged from the at least two housing bores due to gravitational force. The at least one discharge opening thus enables dehumidification of the material in a simple manner

The invention is further based on the object of creating a processing installation which enables the processing of material with a low bulk density in a simple and economical manner

This object is achieved by a processing installation having a processing screw machine for processing material and a feeding screw machine according to the invention for feeding the material to the processing screw machine. The advantages of the processing installation according to the invention correspond to the advantages of the feeding screw machine according to the invention already described. The processing installation may in particular be further embodied with at least one feature described above.

Due to the fact that the feeding screw machine draws in a comparatively large amount of material and compresses it upon conveying in the conveying direction to the processing screw machine, the feeding screw machine has a high throughput. This provides the processing screw machine with a large amount of compressed material which can be easily taken in by the processing screw machine. The processing screw machine can thus be operated economically with a high degree of filling and a high throughput.

The feeding screw machine is preferably designed as a side-feeding screw machine, which is laterally connected to the processing screw machine.

The processing screw machine comprises a housing with at least one housing bore. An associated treatment element shaft is rotatably arranged in the at least one housing bore for processing the supplied material. The processing screw machine is preferably designed as a multi-shaft screw machine. Preferably, at least two housing bores are formed in the housing, which penetrate each other and have the shape of a horizontal figure eight in cross-section. The at least two associated treatment element shafts are rotatably arranged in the at least two housing bores and can preferably be driven in rotation in the same directions of rotation. The at least two treatment element shafts are preferably designed to mesh tightly with each other. A material supply opening for supplying the compressed material is formed in the housing, which is in communication with the feeding opening of the feeding screw machine. The material supply opening is fed with the material to be processed by the feeding screw machine. Preferably, the material supply opening of the processing screw machine is formed laterally. The material supply opening corresponds in cross-section to the feeding opening. The at least two screw shafts preferably extend through the feeding opening and protrude beyond the housing. The protruding part of the at least two screw shafts preferably opens into the material supply opening and extends into at least two connecting bores so that the compressed material is conveyed to the at least one housing bore of the processing screw machine. The at least two connecting bores prolong the at least two housing bores of the feeding screw machine and define in particular a free cross-sectional area which preferably decreases monotonically, with the at least two screw shafts.

The at least one treatment element shaft of the processing screw machine has an outer diameter D_{A} and an inner diameter D₁. The following applies in particular to the ratio D_{A}/D₁: 1.5≤D_{A}/D₁≤1.8.

For a ratio D applies:

$$D = \frac{{D}_{a} ( {x}_{3} ) / {D}_{i} ( {x}_{3} )}{{D}_{A} / {D}_{I}} ,$$

wherein
Dₐ(x₃) represents a screw outer diameter of the at least two screw shafts at a conveying point x₃ which corresponds to a screw shaft end of the at least two screw shafts, and
Dᵢ(x₃) describes a screw inner diameter of the at least two screw shafts at the conveying point x₃.

For the ratio D, the following applies in particular: 0.66≤D≤1.61, in particular 0.94≤D≤1.48.

A processing installation configured such that the processing screw machine has at least one treatment element shaft with an outer diameter D_{A} and that the at least two screw shafts have a screw outer diameter Dₐ(x₁) in a cross-sectional plane at a conveying point x₁ which corresponds to a screw shaft start, wherein: 1≤Dₐ(x₁)/D_{A}≤4, in particular 1.5≤Dₐ(x₁)/D_{A}≤3, in particular 1.8≤Dₐ(x₁)/D_{A}≤2.5, ensures a simple and economical operation. Due to the comparatively large screw outer diameter Dₐ(x₁) the feeding screw machine has a comparatively large free cross-sectional area A(x₁), such that a large amount of the material can be taken in and fed in compressed form to the processing screw machine.

A processing installation configured such that the processing screw machine has at least one treatment element shaft with an outer diameter D_{A} and that the at least two screw shafts have a screw outer diameter Dₐ(x₃) in a cross-sectional plane at a conveying point x₃, which corresponds to a screw shaft end, wherein: 1≤Dₐ(x₃)/D_{A}≤1.5, in particular 1.1≤Dₐ(x₃)/D_{A}≤1.4, in particular 1.2≤Dₐ(x₃)/D_{A}≤1.3, ensures a simple and economical operation. The comparatively large screw outer diameter Dₐ(x₃) ensures that the compressed material is provided in a simple and reliable manner to the processing screw machine with the desired throughput and that the latter can take in the compressed material.

The invention is further based on the object of creating a method which makes it possible to operate a processing installation with low bulk density material in a simple and economical manner

This object is achieved by a method for operating a processing installation, comprising the steps of providing a processing installation according to the invention, and supplying material through the supply opening into the at least two housing bores of the feeding screw machine, conveying the material in the conveying direction to the feeding opening and continuously compressing the material at least regionally while conveying, and feeding the compressed material to the processing screw machine. The advantages of the method according to the invention correspond to the advantages of the feeding screw machine according to the invention and the processing installation according to the invention, which have already been described.

The method according to the invention can in particular be further embodied with at least one feature described above.

The material has a bulk density ρ. The following applies in particular to the bulk density ρ: 5 g/dm³≤ρ≤600 g/dm³, in particular 10 g/dm³≤ρ≤250 g/dm³, in particular 15 g/dm³≤ρ≤200 g/dm³, and in particular 20 g/dm³<ρ≤100 g/dm³. The material has a maximum material dimension aₘₐₓ, wherein in particular: 1 mm≤aₘₐₓ≤50 mm, in particular 5 mm≤aₘₐₓ≤35 mm, and in particular 10 mm≤aₘₐₓ≤20 mm.

The material is preferably a foil material. The foil material has a foil thickness t. The following applies in particular to the foil thickness t: 10 μm≤t≤400 μm, in particular 15 μm≤t≤300 μm, and in particular 20 μm≤t≤200 μm.

The material preferably comprises recycled material and/or fillers, such as powdery fillers and/or reinforcing materials or reinforcing fibers and/or fiber pellets.

The recycled material is, for example, in the form of shreds, flakes and/or pellets. The recycled material is, for example, waste foil material.

The feeding screw machine is operated at a speed n, wherein the following applies in particular: 50 rpm≤n≤1000 rpm, in particular 100 rpm≤n≤800 rpm, and in particular 200 rpm≤n≤600 rpm. The feeding screw machine is further operated with a torque M_{d} per screw shaft, wherein the following applies in particular for a ratio of the torque M_{d} to a respective center distance a(x₁): 0.1 Nm/cm³≤M_{d}/a(x₁)³≤0.8 Nm/cm³, in particular 0.15 Nm/cm³≤M_{d}/a(x₁)³≤0.5 Nm/cm³, and in particular 0.2 Nm/cm³≤M_{d}/a(x₁)³≤0.35 Nm/cm³.
a(x₁) denotes a respective center distance of the axes of rotation associated with the at least two screw shafts at a conveying point x₁ which corresponds to a screw shaft start of the at least two screw shafts.

The feeding screw machine is operated in particular with a dimensionless throughput

$$Φ = \frac{\dot{v}}{n \cdot {{D}_{a} ( {x}_{1} )}^{3}} ,$$

wherein
\dot{ν} indicates a volume flow of the material supplied to the feeding screw machine,
n designates a rotational speed of the at least two screw shafts and
Dₐ(x₁) denotes a screw outer diameter of the at least two screw shafts at a conveying point x₁ which corresponds to a screw shaft start of the at least two screw shafts.

The following applies in particular to the throughput Φ: 0.1≤Φ≤1.2, in particular 0.25≤Φ≤1, and in particular 0.3≤Φ≤0.8.

Further features, advantages and details of the invention will be apparent from the following description of several embodiments.

### BRIEF DESCRIPTION OF THE DRAWING

FIG. 1 shows a side view of a processing installation with a processing screw machine and a feeding screw machine according to a first embodiment,

FIG. 2 shows a top view onto the processing installation in FIG. 1,

FIG. 3 shows a side view of the feeding screw machine in FIG. 1 without the processing screw machine,

FIG. 4 shows a top view onto the feeding screw machine in FIG. 3,

FIG. 5 shows a vertical section through the processing screw machine and the feeding screw machine along the section line V-V in FIG. 2,

FIG. 6 shows a horizontal section through the processing screw machine and the feeding screw machine along the section line VI-VI in FIG. 5,

FIG. 7 shows a vertical section through the feeding screw machine along the section line VII-VII in FIG. 3 at a screw shaft start,

FIG. 8 shows a vertical section through the feeding screw machine along the section line VIII-VIII in FIG. 3 at one end of the housing,

FIG. 9 shows a diagram of a throughput of the feeding screw machine as a function of a rotational speed for different materials, and

FIG. 10 shows a vertical section in the region of an inlet hopper of a feeding screw machine according to a second embodiment.

### DESCRIPTION OF THE PREFERRED EMBODIMENTS

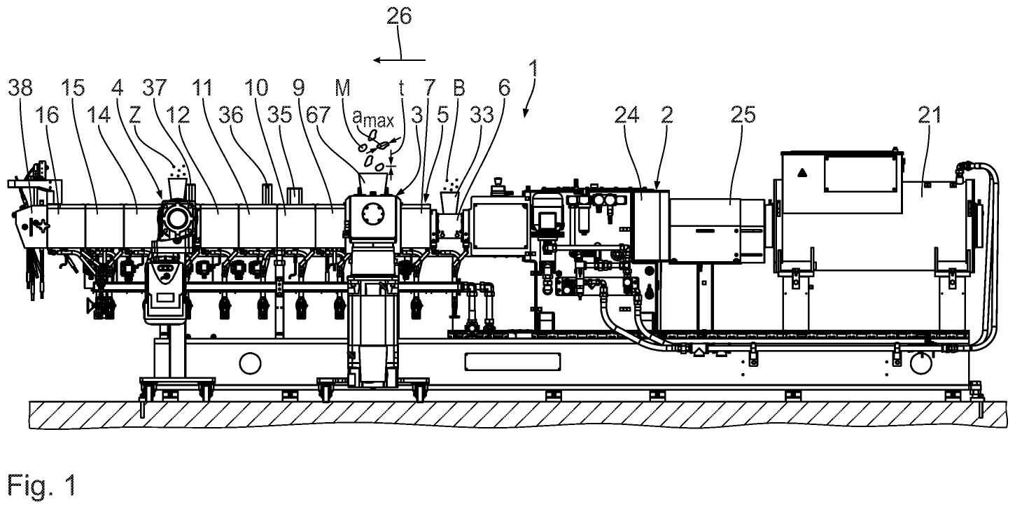

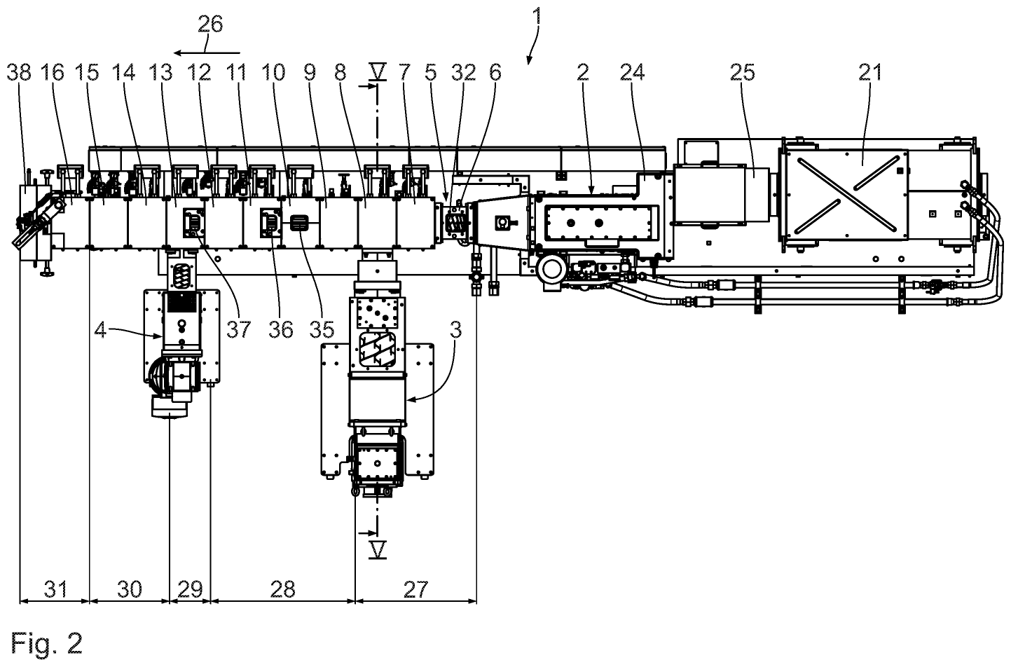

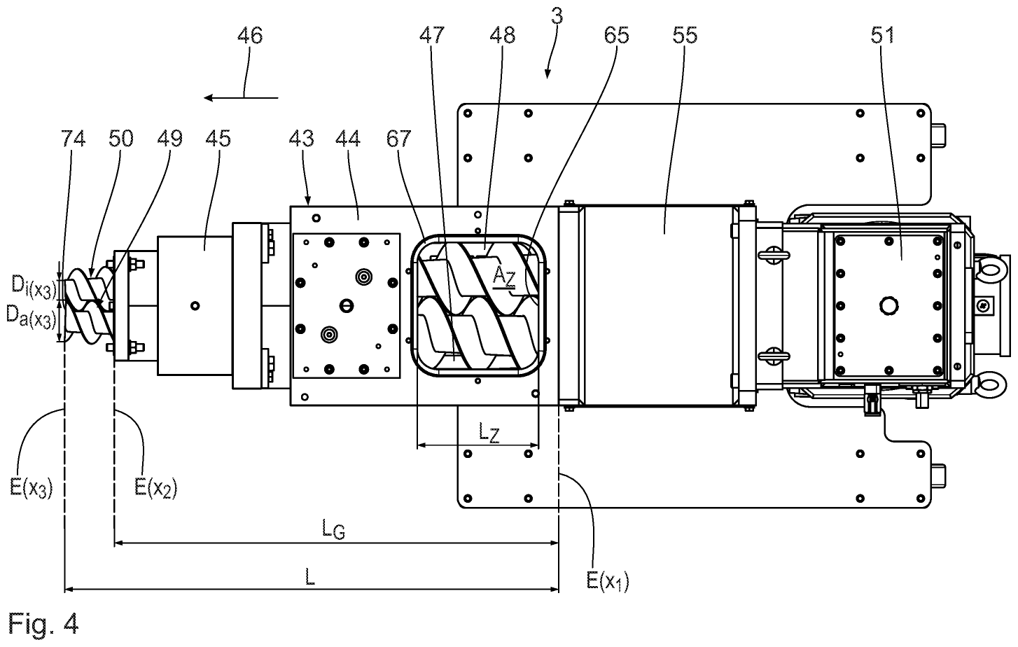

A first embodiment of the invention is described below with reference to FIGS. 1 to 9. The processing installation 1 shown in FIGS. 1 and 2 comprises a processing screw machine 2, a first feeding screw machine 3 for feeding the processing screw machine 2 with a material M having a low bulk density, and a second feeding screw machine 4 for feeding additives Z to the processing screw machine 2.

The processing screw machine 2 comprises a housing 5 with a plurality of housing portions 6 to 16 arranged one after the other. The housing portions 6 to 16 are joined together to form the housing 5. The processing screw machine 2 is designed as a multi-shaft screw machine. Two housing bores 17, 18 are formed in the housing 5, which are parallel to each other and penetrate each other, and which have the shape of a horizontal figure eight in cross-section. Two treatment element shafts 19, 20 are arranged concentrically in the housing bores 17, 18, which can be driven in rotation about associated axes of rotation 22, 23 by an electric drive motor 21. A branching gear 24 is arranged between the treatment element shafts 19, 20 and the drive motor 21. A coupling 25 is then arranged between the drive motor 21 and the branching gear 24. The treatment element shafts 19, 20 are driven in the same direction by the drive motor 21, i.e. in the same directions of rotation about the axes of rotation 22, 23.

The processing screw machine 2 has, one after the other in a processing direction 26, a first intake zone 27, a plasticizing zone 28, a second intake zone 29, a homogenizing zone 30 and a discharge zone 31.

In the first intake zone 27, a base material B to be processed is supplied to the processing screw machine 2. For this purpose, a first material supply opening 32 is formed in the housing portion 6. A hopper 33 is arranged on the housing portion 6, which opens into the first material supply opening 32. The base material B is, for example, a granular plastic material. In the processing direction 26 downstream from the first material supply opening 32, the material M is supplied to the processing screw machine 2. The material M is, for example, a recycled material. For this purpose, a second material supply opening 34 is formed in the housing portion 8. The second material supply opening 34 is formed laterally. Connecting bores extend laterally from the second material supply opening 34 through the housing portion 8 and open into the housing bore 17. It is also possible to exclusively supply the material M via the second material supply opening 34 in the first intake zone 27 and not to supply any base material B via the first material supply opening 32. In this case, the first material supply opening 32 can be used for venting. The second material supply opening 34 can also be formed in the housing portion 6 or 7.

The base material B and the material M are conveyed to the plasticizing zone 28 and melted into a material melt there. The processing screw machine 2 comprises degassing units 35, 36 which are arranged in the plasticizing zone 28 on the housing portions 10, 11 and are connected to associated degassing openings in the housing portions 10, 11.

The material melt is conveyed to the second intake zone 29. In the second intake zone 29, the additives Z are supplied to the material melt. For this purpose, a third material supply opening, not shown in more detail, is formed in the housing portion 13. The third material supply opening extends laterally through the housing portion 13 and opens into the housing bore 17. The second feeding screw machine 4 has a common design and is not described in more detail. The second feeding screw machine 4 is laterally connected to or attached to the housing portion 13. In the second intake zone 29, a degassing unit 37 is arranged on the housing portion 13 which opens into a degassing opening, not shown in more detail.

The material melt is conveyed together with the additives Z into the homogenizing zone 30. In the homogenizing zone 30, the material melt is mixed with the additives Z and homogenized.

In the discharge zone 31, the material melt provided with the additives Z is discharged. A nozzle plate 38 is arranged on the last housing portion 16, which forms a discharge opening not shown in more detail.

For forming the first intake zone 27, the plasticizing zone 28, the second intake zone 29, the homogenizing zone 30 and the discharge zone 31, the treatment element shafts 19, 20 usually comprise treatment elements 39, 40 which are arranged in a rotationally fixed manner on associated shafts 41, 42. The treatment elements 39, 40 are designed as screw elements and/or kneading elements. Preferably, the kneading elements are designed as kneading disks, whereby in particular a plurality of kneading disks are connected in one piece to form a kneading block. The treatment element shafts 19, 20 have an outer diameter DA and an inner diameter DI. In particular, the following applies: 1.5≤D_{A}/D₁≤1.8.

The first feeding screw machine 3 is designed as a two-shaft side-feeding screw machine. The feeding screw machine 3 comprises a housing 43 which has two housing portions 44, 45. The housing portions 44, 45 are arranged one after the other in a conveying direction 46 and are connected to each other to form the housing 43. Two housing bores 47, 48 are formed in the housing 43, which penetrate each other and have the shape of a horizontal figure eight in cross-section. Two screw shafts 49, 50 are arranged in the housing bores 47, 48, which can be driven in rotation in the same direction about associated axes of rotation 53, 54 by means of an electric drive motor 52 via an angular branching gear 51.

The feeding screw machine 3 comprises a coupling housing 55 which connects the housing 43 to the angular branching gear 51. The coupling housing 55 is also referred to as the gearbox lantern. Two output shafts 56, 57 of the angular branching gear 51 extend into the coupling housing 55.

The screw shafts 49, 50 each comprise a screw element 58, 59, which is formed in one piece with an associated shaft 60, 61. Respective ends of the shafts 60, 61 extend into the coupling housing 55 and are connected to the output shafts 56, 57 by means of coupling sleeves 62, 63. For sealing the shafts 60, 61, the feeding screw machine 3 comprises packing glands 70, 71 attached to the coupling housing 55.

The feeding screw machine 3 comprises a mobile frame 64 to which the coupling housing 55 and thus the angular branching gear 51 with the drive motor 52 connected thereto and the housing 43 are attached.

The feeding screw machine 3 comprises a supply opening 65 and a feeding opening 66. The supply opening 65 is formed in the first housing portion 44. The feeding screw machine 3 includes an inlet hopper 67 which opens into the supply opening 65. The supply opening 65 is formed on an upper side of the first housing portion 44 and opens into the housing bores 47, 48 via a supply chute. The supply opening 65 has a length L_{Z} n the conveying direction 46 and a free supply opening cross-sectional area A_{Z}.

The feeding opening 66 is formed at an end of the second housing portion 45 facing the processing screw machine 2. The feeding opening 66 is formed and arranged congruently with the second material supply opening 34. The screw shafts 49, 50 extend beyond the feeding opening 66 and open into the second material supply opening 34. The feeding opening 66 thus serves to feed the material M into the processing screw machine 2.

A discharge opening 68 is formed in the second housing portion 45 for discharging liquid. The discharge opening 68 is arranged on an underside of the second housing portion 45. The discharge opening 68 can be closed by means of a closure element 69.

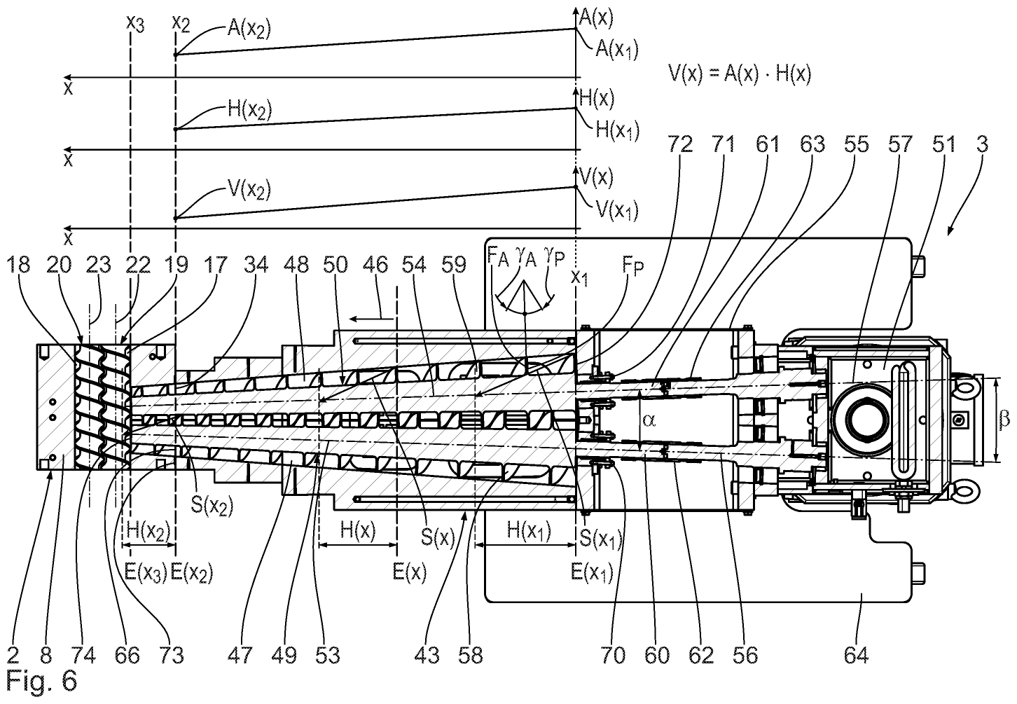

The conveying direction 46 defines an x-axis. The x-axis has its origin at a screw shaft start 72 of the screw shafts 49, 50. The origin or screw shaft start 72 is referred to below as conveying point xi. A housing end 73 of the housing 43 is hereinafter referred to as conveying point x₂. Furthermore, a screw shaft end 74 of the screw shafts 49, 50 is hereafter referred to as conveying point x₃. Perpendicularly to the x-axis, associated cross-sectional planes E(x) are generally defined at random conveying points x₁≤x≤x₃. The x-axis and an exemplary cross-sectional plane E(x) are illustrated in FIG. 6.

The screw shafts 49, 50 are of conical design and are conically arranged in the associated housing bores 47, 48. The axes of rotation 53, 54 enclose an angle α, wherein: 0°<α≤45°, in particular 1°≤α≤20°, and in particular 2°≤α≤10°. The output shafts 56, 57 enclose an angle β in a corresponding manner, wherein: β=α.

The screw shafts 49, 50 have a number of threads N, wherein: N=2. The screw shafts 49, 50 are thus formed with two threads. In order to increase a free cross-sectional area A(x) between the housing 43 and the screw shafts 49, 50 in a respective cross-sectional plane E(x), the screw shafts 49, 50 have a thrust edge profile on a respective active flank F_{A} and on a respective passive flank F_{P}. The respective active flank F_{A} has a flank angle γ_{A}. Correspondingly, the respective passive flank F_{P} has a flank angle γ_{P}. The flank angle γ_{A} and/or the flank angle γ_{P} can be constant or change, in particular increase, in the conveying direction 46. Due to the double thread design, the screw shafts 49, 50 each have two screw flights 75, 76 in the respective cross-sectional plane E(x). Each screw flight 75, 76 has a respective inclination in the respective cross-sectional plane E(x) at a respective associated screw crest, i.e. at a screw outer diameter Dₐ(x). The inclinations of the screw flights 75, 76 differ slightly from each other due to the angle α. An inclination S(x) of the screw shafts 49, 50 is defined as the mean value of the inclinations of the screw flights 75, 76 in the respective cross-sectional plane E(x). The inclination S(x) decreases strictly monotonically in the conveying direction 46. The inclination S(x) is generally illustrated in FIG. 6. The inclination S(x) defines a pitch H(x) for the respective cross-sectional plane E(x). The pitch H(x) is a notional value related to the inclination S(x) in the cross-sectional plane E(x). Due to the fact that the inclination S(x) decreases strictly monotonically in the conveying direction 46, the pitch H(x) is greater than an actual pitch of the screw shafts 49, 50. The pitch H(x) is defined at one revolution with the inclination S(x).

The free cross-sectional area A(x) and the corresponding pitch H(x) define a free volume V(x) for the respective cross-sectional plane E(x), wherein: V(x)=A(x)·H(x). Due to the conical design and due to the pitch H(x) decreasing strictly monotonically in the conveying direction 46, the free volume V(x) decreases strictly monotonically in the conveying direction 46. Due to the fact that the free cross-sectional area A(x) and the pitch H(x) decrease strictly monotonically in the conveying direction 46, the material M is compressed in the conveying direction 46 and compressed transversely to the conveying direction 46 when being conveyed.

The screw shafts 49, 50 have a screw outer diameter Dₐ(x) and an associated screw inner diameter Dᵢ(x) in the respective cross-sectional plane E(x), which decrease strictly monotonically in the conveying direction 46. For Dₐ(x)/Dᵢ(x) the following in particular applies: 1.55≤Dₐ(x)/Dᵢ(x)≤2.5, in particular 1.8≤Dₐ(x)/Dᵢ(x)≤2.2. Preferably, Dₐ(x)/Dᵢ(x) is constant in the conveying direction 46.

The housing bores 47, 48 have a housing bore diameter D_{G}(x), in the respective cross-sectional plane E(x), which decreases strictly monotonically in the conveying direction 46. A relative clearance

$$s ( x ) = \frac{{D}_{G} ( x ) - {D}_{a} ( x )}{{D}_{a} ( x )}$$

is constant in the conveying direction 46 and/or increases in the conveying direction 46.

For a ratio of the pitch H(x) to the screw outer diameter Dₐ(x), the following applies in particular: 1<H(x)/Dₐ(x)≤2, in particular 1.2≤H(x)/Dₐ(x)≤1.5. The ratio H(x)/Dₐ(x) is in particular constant in the conveying direction 46.

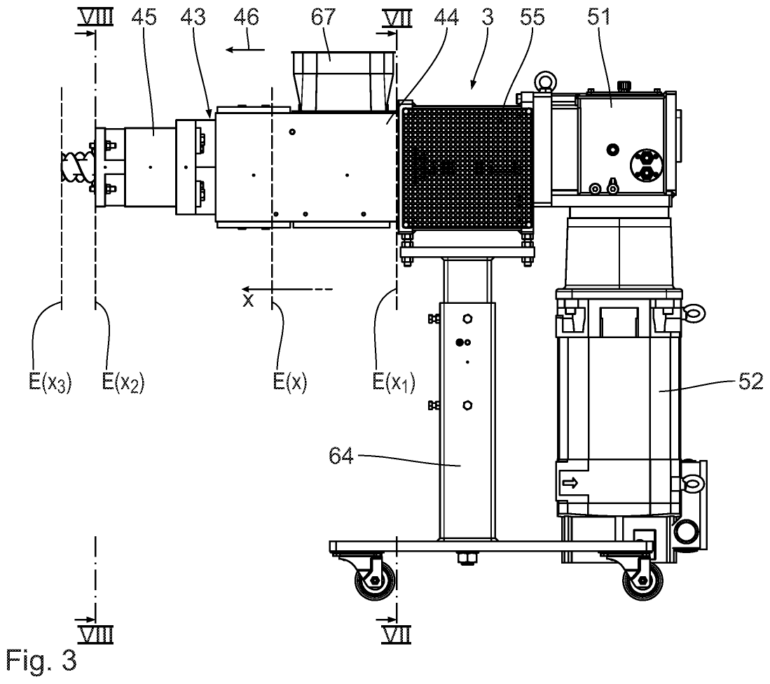

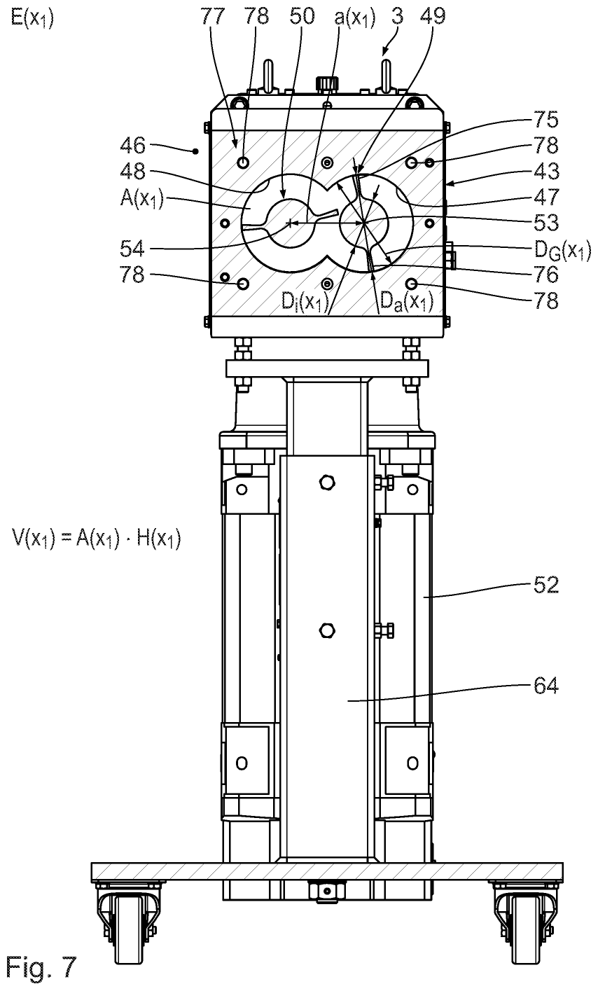

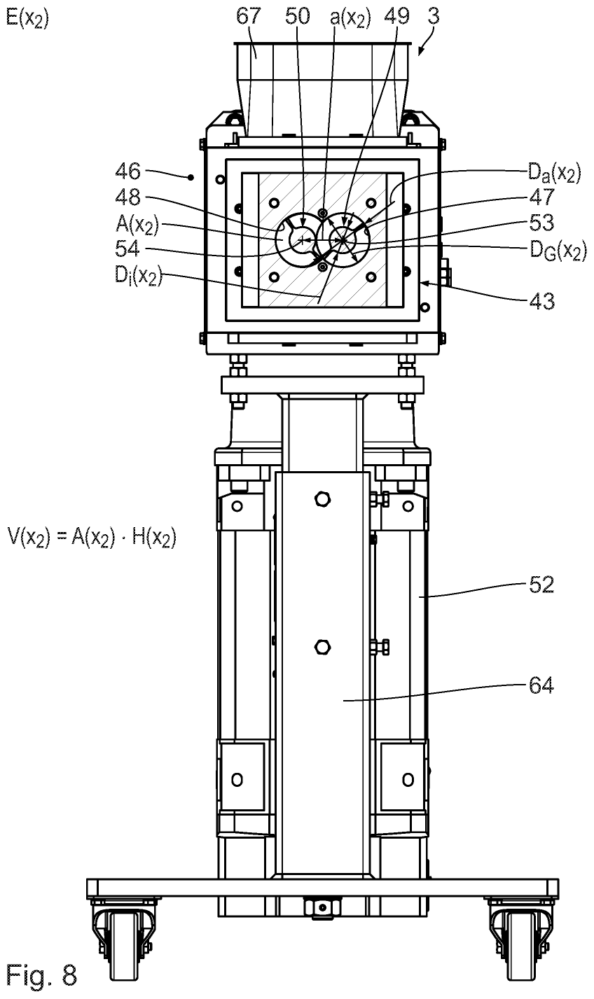

FIG. 3 and FIG. 6 show a cross-sectional plane E(x₁) at the conveying point x₁, a cross-sectional plane E(x₂) at the conveying point x₂ and a cross-sectional plane E(x₃) at the conveying point x₃. FIG. 7 shows the feeding screw machine 3 in the cross-sectional plane E(x₁), whereas FIG. 8 shows the feeding screw machine 3 in the cross-sectional plane E(x₂).

In the cross-sectional plane E(x₁) the screw shafts 49, 50 have a screw outer diameter Dₐ(x₁) and a screw inner diameter Dᵢ(x₁). A center distance of the axes of rotation 53, 54 is a(x₁). The housing bores 47, 48 have a housing bore diameter D_{G}(x₁). The screw shafts 49, 50 together with the housing 43 define a free cross-sectional area A(x₁) of the housing bores 47, 48.

The screw flights 75, 76 have an inclination S(x₁) in the cross-sectional plane E(x₁), which defines a pitch H(x₁) for one revolution. With reference to the cross-sectional plane E(x₁), the following applies for a first free volume V(x₁): V(x₁)=A(x₁)·H(x₁).

In the cross-sectional plane E(x₂) at the conveying point x₂ or the housing end 73, the screw shafts 49, 50 have a screw outer diameter Dₐ(x₂) and a screw inner diameter Dᵢ(x₁). The axes of rotation 53, 54 have a center distance a(x₂). The housing bores 47, 48 have a housing bore diameter D_{G}(x₂). The housing bores 47, 48 and the screw shafts 49, 50 define a free cross-sectional area A(x₂). The screw flights 75, 76 have an inclination S(x₂) in the cross-sectional plane E(x₂), which defines a pitch H(x₂) for one revolution. With reference to the cross-sectional plane E(x₂), the following applies for a second free volume V(x₂): V(x₂)=A(x₂)·H(x₂).

In the cross-sectional plane E(x₃) the screw shafts 49, 50 have a screw outer diameter Dₐ(x₃) and a screw inner diameter D i (x₃). The screw flights 75, 76 have an inclination S(x₃) in the cross-sectional plane E(x₃), which defines a pitch H(x₃) for one revolution. For a mean screw outer diameter Dₐₘ the following applies:

$${D}_{am} = \frac{{D}_{a} ( {x}_{1} ) + {D}_{a} ( {x}_{3} )}{2} .$$

For a compression V(x₁)/V(x₂) in particular: 1≤V(x₁)/V(x₂)≤20, in particular 2≤V(x₁)/V(x₂)≤15, and in particular 4≤V(x₁)/V(x₂)≤10.

For a ratio A(x₁)/A(x₂) in particular: 1≤A(x₁)/A(x₂)≤8, in particular 1.5≤A(x₁)/A(x₂)≤7, in particular 2≤A(x₁)/A(x₂)≤6.

For a ratio H(x₁)/H(x₂) in particular: 1≤H(x₁)/H(x₂)≤8, in particular 1.1≤H(x₁)/H(x₂)≤5, and in particular 1.2≤H(x₁)/H(x₂)≤3.

For a ratio

$$d = \frac{{D}_{a} ( {x}_{1} ) / {D}_{1} ( {x}_{1} )}{{D}_{a} ( {x}_{3} ) / {D}_{i} ( {x}_{3} )} ,$$

in particular:
0.62≤d≤1.22, in particular 0.82≤d≤1. Preferably: d=1.

For a ratio

$$h = \frac{H ( {x}_{1} ) / {D}_{a} ( {x}_{1} )}{H ( {x}_{3} ) / {D}_{a} ( {x}_{3} )} ,$$

in particular:
0.5≤h≤1.5, in particular 0.8≤h≤1.2, and in particular 0.9≤h≤1.1. Preferably: h=1.

The screw shafts 49, 50 have a length L in the conveying direction 46. For a tapering

$$K = \frac{{{D}_{a} ( {x}_{1} )}^{2}}{L \cdot {D}_{a} ( {x}_{3} )} ,$$

in particular: 0.05≤K≤1, in particular 0.1≤K≤0.9, in particular 0.15≤K≤0.8, in particular 0.2≤K≤0.7, in particular 0.25≤K≤0.6 and in particular 0.3≤K≤0.4.

For a ratio Dₐ(x₁)/Dₐ(x₃), in particular: 1≤Dₐ(x₁)/Dₐ(x₃)≤4, in particular 1.2≤Dₐ(x₁)/Dₐ(x₃)≤3, and in particular 1.3≤Dₐ(x₁)/Dₐ(x₃)≤2.5.

A screw inner diameter Dᵢ(x) of the at least two screw shafts is constant or monotonically decreasing or strictly monotonically decreasing at least in some regions in the conveying direction.

For a ratio of a screw inner diameter Dᵢ(x₁) of the at least two screw shafts at the conveying point x₁ and a screw inner diameter D₁(x₃) of the at least two screw shafts at the conveying point x₃, the following applies in particular: 1≤Dᵢ(x₁)/Dᵢ(x₃)≤5, in particular 1.25≤Dᵢ(x₁)/Dᵢ(x₃)≤4, and in particular 1.5≤Dᵢ(x₁)/Dᵢ(x₃)≤3.

The smaller the tapering K, the greater the length L. If the length L is too great, large lever forces act on the at least two screw shafts, which places great stress on the bearings for supporting the at least two screw shafts on the housing and/or the bearings of a gearbox. Furthermore, if the length L of the at least two screw shafts is too great, the production of the feeding screw machine is uneconomical.

The greater the tapering K, the smaller the length L. If the length L is too small, the conveying efficiency of the at least two screw shafts is poor.

The length L is in particular the distance between the conveying points xi and x₃. The following applies in particular to the length L: 0.3 m≤L≤4 m, in particular 0.5 m≤L≤3.5 m, in particular 0.7 m≤L≤3 m and in particular 0.9 m≤L≤2.5 m.

In an axial section, an envelope of the respective screw shaft encloses an angle with the associated axis of rotation which is in particular at least 2 degrees and at most 10 degrees, in particular at least 2.5 degrees and at most 8 degrees, and in particular at least 3 degrees and at most 6 degrees. The envelope of the respective screw shaft is defined by the screw outer diameter at the respective conveying point.

For the ratio of a housing length L_{G} of the housing 43 to the screw outer diameter Dₐ(x₁), the following preferably applies: 2≤L_{G}/Dₐ(x₁)≤15, in particular 3≤L_{G}/Dₐ(x₁)≤10, and in particular 4≤L_{G}/Dₐ(x₁)≤6.

For a ratio Dₐ(x₁)/D_{A}, in particular: 1≤Dₐ(x₁)/D_{A}≤4, in particular 1.5≤Dₐ(x₁)/D_{A}≤3, in particular 1.8≤Dₐ(x₁)/D_{A}≤2.5.

Further, for a ratio Dₐ(x₃)/D_{A}, the following in particular applies: 1≤Dₐ(x₃)/D_{A}≤1.5, in particular 1.1≤Dₐ(x₃)/D_{A}≤1.4, in particular 1.2≤Dₐ(x₃)/D_{A}≤1.3.

For a ratio

$$D = \frac{{D}_{a} ( {x}_{3} ) / {D}_{i} ( {x}_{3} )}{{D}_{A} / {D}_{I}} ,$$

in particular: 0.66≤D≤1.61, in particular 0.94≤D≤1.48

The feeding screw machine 3 comprises a temperature control device 77.

The temperature control device 77 serves to heat and/or cool the housing 43. The temperature control device 77 comprises fluid channels 78 formed in the first housing portion 44. The fluid channels 78 are connected to a fluid pump not shown in more detail. The fluid channels 78 serve to receive a temperature control fluid. The temperature control fluid can be heated and/or cooled in a conventional manner by means of a temperature control unit not shown in greater detail. The temperature control fluid is, for example, water.

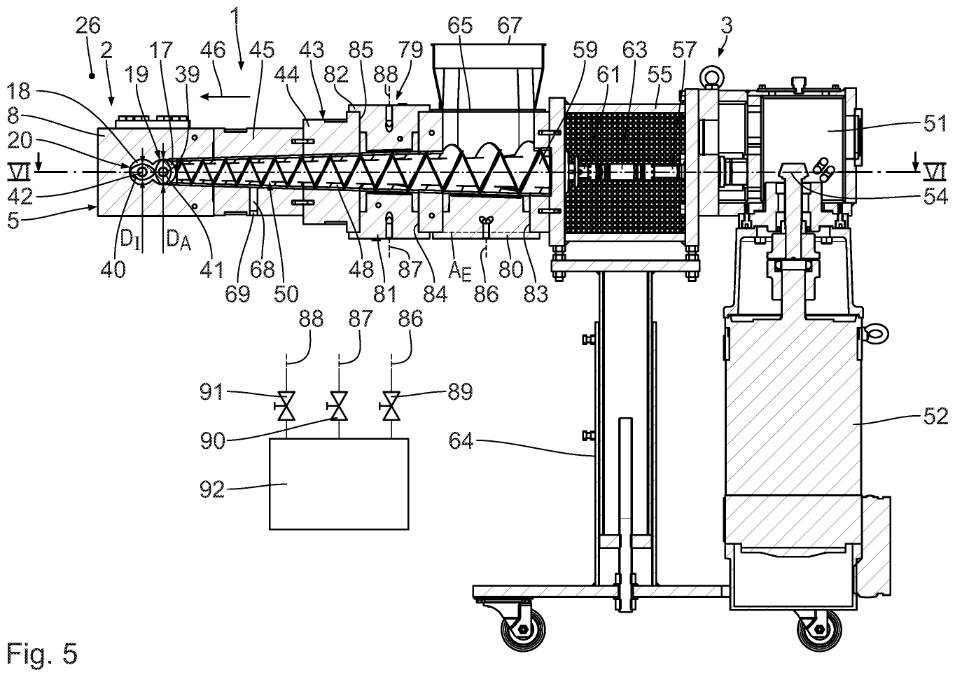

The feeding screw machine 3 comprises a degassing device 79. The degassing device 79 comprises three degassing inserts 80, 81, 82 which are inserted into associated degassing openings 83, 84, 85 of the first housing portion 44. The degassing device 79 is illustrated in FIG. 5.

A first degassing opening 83 is formed on an underside of the first housing portion 44 and faces the supply opening 65. A second degassing opening 84 and a third degassing opening 85 are formed in the first housing portion 44 downstream from the first degassing opening 83 in the conveying direction 46. The second degassing opening 84 is arranged on the underside, whereas the third degassing opening 85 is formed on the upper side opposite the second degassing opening 84. The degassing inserts 80, 81, 82 are connected to a suction unit 92 via a respective suction line 86, 87, 88 and via a respective valve 89, 90, 91. A volume flow in the respective suction line 86, 87, 88 can be adjusted via the valves 89, 90, 91.

The respective degassing opening 83, 84, 85 has a free degassing area A_{E}. For a ratio of the free degassing area A_{E} to the mean screw outer diameter Dam squared, the following applies in particular: 0.3≤A_{E}/Dₐₘ²≤6, in particular 0.8≤A_{E}/Dₐₘ²≤4.5, and in particular 1.3≤A_{E}/Dₐₘ²≤3.5.

Preferably, the free degassing area A_{E} of the first degassing opening 83 is larger than the free degassing areas A_{E} of the degassing openings 84, 85.

The following applies in particular to the length L_{Z} of the supply opening 65: H(x₁)≤L_{Z}≤2·H(x₁), in particular 1.2·H(x₁)≤L_{Z}≤1.5·H(x₁).

For the ratio of the supply opening cross-sectional area A_{Z} to the mean screw outer diameter Dₐₘ squared, the following applies in particular: 2≤A_{Z}/Dₐₘ²≤7, in particular 2.5≤A_{Z}/Dₐₘ²≤5.5, and in particular 3≤A_{Z}/Dₐₘ²≤4.5.

The functional principle and operation of the processing installation 1 is described below:

In the first intake zone 27, the base material B is supplied via the first material supply opening 32 and the material M is supplied via the second material supply opening 34 into the housing bores 17, 18. The base material B is, for example, in the form of granules. The material M, which is for example a recycled material, is mixed with the base material B. The material M has a bulk density ρ, wherein: 5 g/dm^{3≤ρ≤600} g/dm³, in particular 10 g/dm³≤ρ≤250 g/dm³, in particular 15 g/dm³≤ρ≤200 g/dm³, and in particular 20 g/dm³≤ρ≤100 g/dm³. The material M is present, for example, as shreds, flakes and/or pellets. The material M has a maximum dimension aₘₐₓ, wherein: 1 mm≤aₘₐₓ≤50 mm, in particular 5 mm≤aₘₐₓ≤35 mm, and in particular 10 mm≤aₘₐₓ≤20 mm The material M is, for example, a foil material with a foil thickness t, wherein: 10 μm≤t≤400 μm, in particular 15 μm≤t≤300 μm, and in particular 20 μm≤t≤200 μm.

The material M is supplied to the processing screw machine 2 by means of the first feeding screw machine 3. For this purpose, the material M is supplied via the inlet hopper 67 and the supply opening 65 into the housing bores 47, 48 of the feeding screw machine 3.

The material M is conveyed in the conveying direction 46 by means of the screw shafts 49, 50. For this purpose, the screw shafts 49, 50 are driven in rotation in the same directions of rotation by means of the electric drive motor 52 via the angular branching gear 51. Due to the fact that both the free cross-sectional area A(x) and the pitch H(x) decrease strictly monotonically in the conveying direction 46, the free volume V(x) also decreases strictly monotonically in the conveying direction 46. When being conveyed, the material M is thus compressed in the conveying direction 46 as well as transversely to the conveying direction 46. Due to the fact that a local derivative of the free cross-sectional area A(x), a local derivative of the pitch H(x) and a local derivative of the free volume V(x) are continuous in the conveying direction 46, i.e. they do not jump, compression takes place continuously in a simple and reliable manner. The local course of the free cross-sectional area A(x), the pitch H(x) and the free volume V(x) is illustrated in FIG. 6.

Air escaping from the material M due to compression is sucked out via the degassing device 79. The respective volume flow in the suction lines 86, 87, 88 can be adjusted as required via the valves 89, 90, 91. Heat generated by the compression can be removed from the housing 43 by means of the temperature control device 77.

The material M is dehumidified by the compression so that liquid accumulates in the housing bores 47, 48. The liquid can be discharged via the discharge opening 68.

The compressed material M is supplied through the feeding opening 66 and through the connecting bores of the housing portion 8 into the housing bores 17, 18. The connecting holes formed in the housing portion 8 continue the course of the housing bores 47, 48 up to the screw shaft end 74 or the housing bores 17, 18.

The screw shafts 49, 50 are driven in rotation at a rotational speed n and a torque M_{d} per screw shaft 49, 50 by means of the drive motor 52 and the angular branching gear 51. The following applies in particular to the rotational speed n: 50 rpm≤n≤1000 rpm, in particular 100 rpm≤n≤800 15 rpm, and in particular 200 rpm≤n≤600 rpm.

For a ratio M_{d}/a(x₁)³, in particular: 0.1 Nm/cm³≤M_{d}/a(x₁)³≤0.8 Nm/cm³, in particular 0.15 Nm/cm³≤M_{d}/a(x₁)³≤0.5 Nm/cm³, and in particular 0.2 Nm/cm³≤M_{d}/a(x₁)³≤0.35 Nm/cm³.

Due to the fact that the feeding screw machine 3 has a large free cross-sectional area A(x) in the region of the supply opening 65, a comparatively large amount of the material M can be supplied to the feeding screw machine 3. The material M is subsequently compressed in the described manner while being conveyed, which enables the processing screw machine 2 to easily and reliably draw in the compressed material M in the first intake zone 27. For a dimensionless throughput

$$Φ = \frac{\dot{v}}{n \cdot {{D}_{a} ( {x}_{1} )}^{3}}$$

of the feeding screw machine 3, the following applies in particular: 0.1≤Φ≤1.2, in particular 0.25≤Φ≤1, and in particular 0.3≤Φ≤0.8. \dot{ν} denotes a volume flow of the material M supplied to the feeding screw machine 3.

The base material B and the material M are conveyed in the processing direction 26 to the plasticizing zone 28 and melted there to form a material melt. Any escaping gases can be removed via the degassing units 35, 36. In the second intake zone 29, additives Z are usually supplied to the material melt, which are homogenously mixed in the homogenizing zone 30. Any escaping gases can in turn be removed via the degassing unit 37. The material melt provided with the additives Z is then discharged in the discharge zone 31 via the nozzle opening.

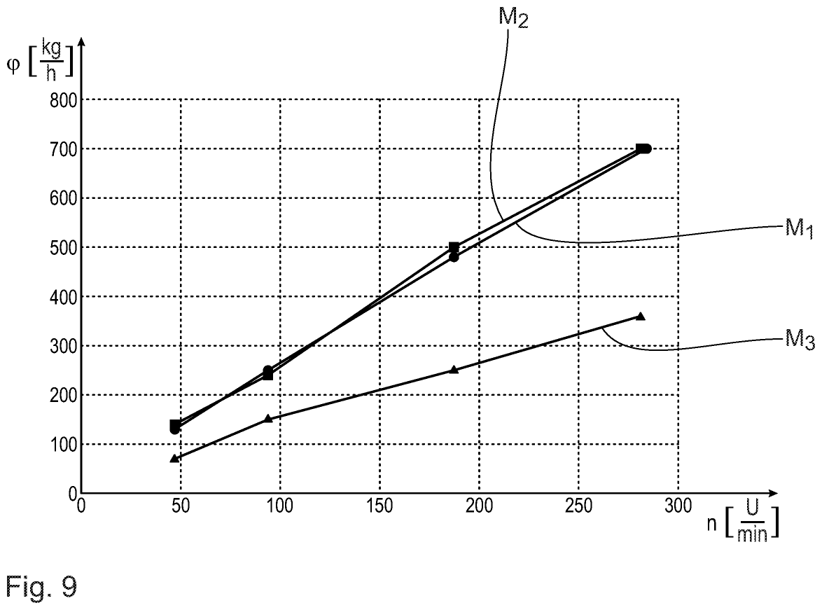

FIG. 9 illustrates in a diagram a throughput y of the feeding screw machine 3 in kg/h as a function of the rotational speed n in rpm for different materials M₁, M₂, and M₃. The material M₁ has a bulk density ρ₁=37 g/dm³, the material M₂ has a bulk density ρ₂=41 g/dm³ and the material M₃ has a bulk density ρ₃=16 g/dm³. In contrast, a common feeding screw machine at a maximum rotational speed of n=600 rpm for material M₁ has a maximum throughput of 100 kg/h, for material M₂ has a maximum throughput of 160 kg/h and for material M₃ has a maximum throughput of 70 kg/h.

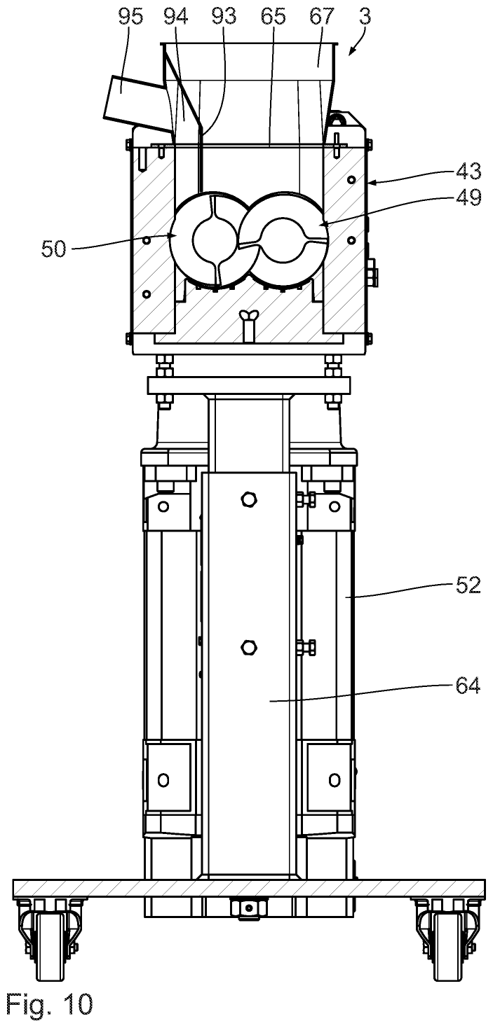

A second embodiment of the invention is described below with reference to FIG. 10. In contrast to the first embodiment, the feeding screw machine 3 25 comprises an inlet hopper 67 which is divided. The inlet hopper 67 has a partition 93 so that a degassing channel 94 is formed in the inlet hopper 67. The degassing channel 94 is connected to a further degassing device 79 via a suction line 95. Air escaping during the supply of the material M can be removed directly via the suction channel 94. With regard to the further construction and the further functional principle of the processing installation 1 and the feeding screw machine 3, reference is made to the preceding embodiment example.

1. A feeding screw machine for feeding a processing screw machine having a housing, at least two housing bores formed in the housing and penetrating each other, a supply opening formed in the housing for supplying material into the at least two housing bores, a feeding opening formed in the housing for feeding the material to a processing screw machine, and at least two screw shafts rotatably arranged in the at least two housing bores for conveying the material a conveying direction from the supply opening to the feeding opening, wherein the at least two housing bores and the at least two screw shafts in a respective cross-sectional plane (E(x)) define a free volume V(x)=A(x)·H(x), wherein
A(x) describes a free cross-sectional area in the cross-sectional plane (E(x)),
H(x) describes a pitch of the screw shafts on a basis of an inclination (S(x)) in the cross-section plane (E(x)), and
x describes a conveying point in the conveying direction; and
wherein for continuous compression of the material, the free volume V(x) decreases monotonically in the conveying direction at least in some regions.

2. The feeding screw machine according to claim 1, wherein a first free volume V(x₁) is defined in a first cross-sectional plane (E(x₁)) at a first conveying point x₁ of the at least two screw shafts and a second free volume V(x₂) is defined in a second cross-sectional plane (E(x₂)) at a second conveying point x₂ of the at least two screw shafts which is located downstream of the first conveying point x₁ in the conveying direction, wherein: 1≤V(x₁)/V(x₂)≤20.

3. The feeding screw machine according to claim 1, wherein a screw outer diameter (Dₐ(x)) of the at least two screw shafts decreases at least regionally in the conveying direction.

4. The feeding screw machine according to claim 1, wherein a tapering
$$K = \frac{{{D}_{a} ( {x}_{1} )}^{2}}{L \cdot {D}_{a} ( {x}_{3} )}$$
is defined for a conical configuration of the at least two screw shafts, wherein 0.05≤K≤1 applies, and wherein
Dₐ(x₁) describes a screw outer diameter of the at least two screw shafts at a conveying point x₁ which corresponds to a screw shaft start of the at least two screw shafts,
Dₐ(x₃) describes a screw outer diameter of the at least two screw shafts at a conveying point x₃ which corresponds to a screw shaft end of the at least two screw shafts, and
L describes a length of the at least two screw shafts.

5. The feeding screw machine according to claim 1, wherein a housing bore diameter (D_{G}(x)) of the at least two housing bores decreases at least regionally in the conveying direction.

6. The feeding screw machine according to claim 1, wherein axes of rotation associated with the at least two screw shafts enclose an angle α, wherein: 0<α≤45°.

7. The feeding screw machine according to claim 1, wherein the at least two screw shafts define in the respective cross-sectional plane (E(x)) a screw outer diameter Dₐ(x) and a screw inner diameter Dᵢ(x), wherein: 1.55<Dₐ(x)/Dᵢ(x)≤2.5.

8. The feeding screw machine according to claim 1, wherein the at least two screw shafts in the respective cross-sectional plane (E(x)) define the pitch H(x) and a screw outer diameter Dₐ(x), wherein: 1≤H(x)/Dₐ(x)≤2.

9. The feeding screw machine according to claim 1, wherein the housing comprises at least two housing portions.

10. The feeding screw machine according to claim 1, wherein the at least two screw shafts each comprise a shaft and at least one screw element which are formed in one piece with one another.

11. The feeding screw machine according to claim 1, comprising at least one degassing device.

12. The feeding screw machine according to claim 1, wherein at least one discharge opening is formed in the housing.

13. A processing installation having a processing screw machine for processing material; and a feeding screw machine according to claim 1 for feeding the material to the processing screw machine.

14. The processing installation according to claim 13, wherein the processing screw machine has at least one treatment element shaft with an outer diameter D_{A}, the at least two screw shafts have a screw outer diameter Dₐ(x₁) in a cross-sectional plane (E(x₁)) at a conveying point x₁ which corresponds to a screw shaft start. wherein: 1≤Dₐ(x₁)/D_{A}≤4.

15. The processing installation according to claim 13, wherein the processing screw machine has at least one treatment element shaft with an outer diameter D_{A}, the at least two screw shafts have a screw outer diameter Dₐ(x₃) in a cross-sectional plane (E(x₃)) at a conveying point x₃, which corresponds to a screw shaft end, wherein: 1≤Dₐ(x₃)/D_{A}≤1.5.

16. A method for operating a processing installation, comprising the following steps: providing a processing installation, supplying material through a supply opening into at least two housing bores of a feeding screw machine, conveying the material in a conveying direction to a feeding opening and continuously compressing the material at least regionally while conveying; and feeding the compressed material to a processing screw machine.
